(19) United States
(12) Patent Application Publication
(10) Pub. No.: US 2026/0369768 A1
(43) Pub. Date: Nov. 19, 2026

(54) PORTABLE ENERGY STORAGE SYSTEM INCLUDING ANTI-PROPAGATION

(71) Applicant: Viridi Parente, Inc., Buffalo, NY (US)

(72) Inventors: Warren Wadman, Grand Island, NY (US); Ed Sniezak, Buffalo, NY (US); Noah Podolefsky, Boulder, CO (US); Nick Knorz, Boulder, CO (US); Albert Yanez, San Jose, CA (US)

(73) Assignee: Viridi Parente, Inc., Buffalo, NY (US)

(21) Appl. No.: 19/742,053

(22) Filed: Jul. 15, 2026

Related U.S. Application Data
(63) Continuation of application No. 18/332,113, filed on Jun. 9, 2023, now abandoned.

(51) Int. Cl. H01M 50/213; H01M 10/42; H01M 10/48; H01M 10/6567; H01M 10/658; H01M 50/256; H02J 3/0073; H02J 7/14

(52) U.S. Cl. CPC H01M 50/213; H01M 10/4207; H01M 10/482; H01M 10/486; H01M 10/6567; H01M 10/658; H01M 50/256; H02J 3/0073; H02J 7/1492; H02J 2207/20

(57) ABSTRACT

Provided in this disclosure is a portable battery system, including battery components that each include battery modules for supplying electrical power at a base voltage. A water-tight, sealed enclosure retains the battery modules within the battery components. Thermal runaway shield (TRS) pouches are associated with each battery module. The TRS pouches include a thermally cooling fluid that ruptures into the battery module from heat produced in a thermal runaway event in the battery module. An inverter is provided for converting electrical power from DC voltage to AC voltage. A portable support structure is included for supporting and moveably transporting components of the portable battery system.

### BACKGROUND

### A. Technical Field

This invention generally pertains to the field of battery systems. The invention particularly pertains to the field of portable lithium-ion battery systems having antipropagation elements for mitigating thermal runaway.

### B. Description of Related Art

Construction sites have a portable diesel generator on hand to power electrical components such as tools, lighting, etc. Demand for electricity on a construction site can be intermittent since electrical components are usually not operated continuously. However, such generators operate continuously to provide availability of electrical power on demand, when the need arises for component operation. Thus, the efficiency of a diesel generator can be as low as 10-20%.

Moreover, diesel generators are known to produce high noise levels. This limits the operability of portable diesel generators in areas such as hospitals or schools where strict noise controls are followed. This also limits the times of operation of portable diesel generators since noise ordinances are enforced during the nighttime, in residential areas for example.

Battery storage systems are commercially available, and are primarily intended for stationary storage applications, such as being placed in a room in a building or on a pad outside the building, to provide electrical power for the building. Lithium-ion battery systems have proliferated as a green energy solution.

Battery-powered systems including lithium-ion batteries can be adapted as a substitute for noisy diesel generators and can provide suitable electrical power at construction sites and other locations. Consequently, there is an increased risk associated with thermal runaway in such batteries. Thermal runaway is an uncontrollable exothermic reaction that can occur within lithium-ion batteries ue to damage, short circuited, or cell defects, resulting in a rapid release of heat.

During thermal runaway, the battery can rapidly reach temperatures of 700 °C. This heating breaks down the electrolytic material in the battery into toxic and flammable gases. This produces flame and can result in an explosion. Moreover, the heat released by the battery can propagate to any nearby batteries, resulting in a chain reaction. Systems including large stacks of batteries can suffer from a catastrophic cascade, resulting in considerable damage, pollution and potentially loss of life.

For at least the above reasons, there is therefore a need for portable battery system that can replace diesel generators at construction sites.

There is also a need for a thermal mitigation system for managing and containing thermal runaway events in batteries.

There is additionally a need for a thermal mitigation system for lithium-ion battery stacks and arrays in which multiple batteries are deployed in a concentrated area.

There is further a need for a thermal mitigation system for lithium-ion batteries that can isolate thermal runaway in a single battery in a stack or array to prevent propagation.

### SUMMARY

Provided in this disclosure is a portable battery system, including one or more battery components. Each of the battery components include a plurality of battery modules for supplying electrical power at a DC voltage. A water-tight, sealed enclosure retains the plurality of battery modules within each of the battery components. One or more thermal runaway shield (TRS) pouches are associated with each of the plurality of battery modules. The TRS pouches each include a thermally cooling fluid that ruptures into the battery module from heat produced in a thermal runaway event in the battery module. An increase in air pressure is associated with gas released from the thermal runaway event in one or more battery cells in one or more of the battery modules of the respective battery component(s). The pressure is relieved through a vent that opens automatically when there is a thermal runaway event. An inverter is provided for converting the electrical power from the DC voltage to an AC voltage. A portable support structure is included for supporting and moveably transporting components of the portable battery system including the one or more battery components.

In the present portable battery system, the portable support structure can include a skid having apertures configured to be raised and lowered by a forklift. The skid can be configured to be received onto a wheeled transport apparatus. In the present portable battery system, a transformer is configured to convert the electrical power from a primary voltage of 480 volts to a secondary voltage of 208 volts.

The present portable battery system also includes a control system for monitoring battery parameters and implementing at least one control function in response to the monitoring. The battery parameters include one or more of battery charge level or temperature. The control system also includes an “internet of things” (IOT) interface for remotely performing the monitoring and implementing. The present system also includes a connection to a backup system that provides electrical charging upon depletion of the battery system.

According to an aspect, the present invention provides a portable battery system that can replace diesel generators at construction sites.

According to another aspect, the present invention provides a thermal mitigation system for managing and containing thermal runaway events in batteries.

According to another aspect, the present invention provides a thermal mitigation system for lithium-ion battery stacks and arrays in which multiple batteries are deployed in a concentrated area.

According to another aspect, the present invention provides a thermal mitigation system for lithium-ion batteries that can isolate thermal runaway in a single battery in a stack or array to prevent a cascade.

Other benefits and advantages of this invention will become apparent to those skilled in the art to which it pertains upon reading and understanding of the following detailed specification.

### BRIEF DESCRIPTION OF THE DRAWINGS

The disclosed portable battery system may take physical form in certain parts and arrangement of parts, embodiments of which will be described in detail in this specification and illustrated in the accompanying drawings which form a part hereof and wherein:

FIG. 1 is a perspective view of a portable battery system in accordance with an exemplary embodiment.

FIGS. 2A and 2B are assembled and exploded views of a battery module incorporated into the portable battery system in accordance with an exemplary embodiment.

FIGS. 3A and 3B are a partially exploded and side sectional views of a stack of battery modules incorporated into the portable battery system in accordance with an exemplary embodiment.

FIG. 4 is an exploded view of a battery component formed of a plurality of battery modules incorporated into the portable battery system in accordance with an exemplary embodiment.

FIGS. 5A, 5B, 5C, and 5D depict stages of assembly of the portable battery system in accordance with an exemplary embodiment.

FIG. 6 is a frontal view depicting an interface for the portable battery system in accordance with an exemplary embodiment.

FIG. 7 is a block diagram of the control system used with portable battery system in accordance with an exemplary embodiment.

FIG. 8 is a perspective view of the portable battery system mounted onto a wheeled transport apparatus in accordance with an exemplary embodiment.

FIG. 9 is a block diagram depicting various components and interconnections of the control system.

### DETAILED DESCRIPTION

Referring now to the drawings wherein the showings are for purposes of illustrating embodiments of the article only and not for purposes of limiting the same, and wherein like reference numerals are understood to refer to like components:

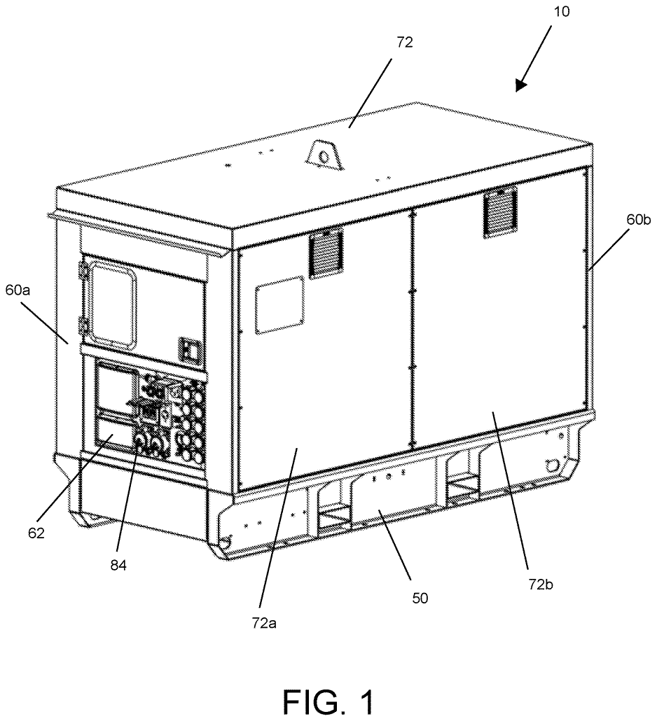

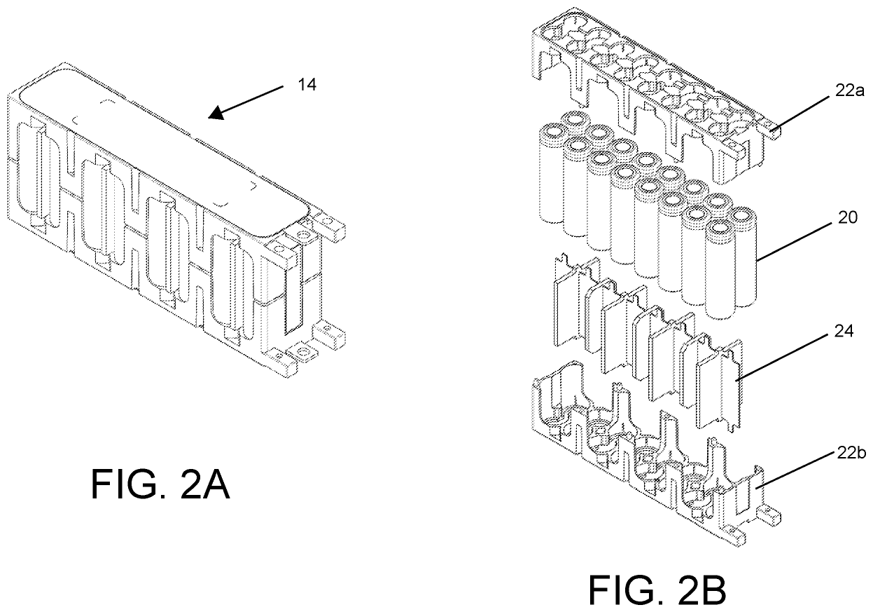

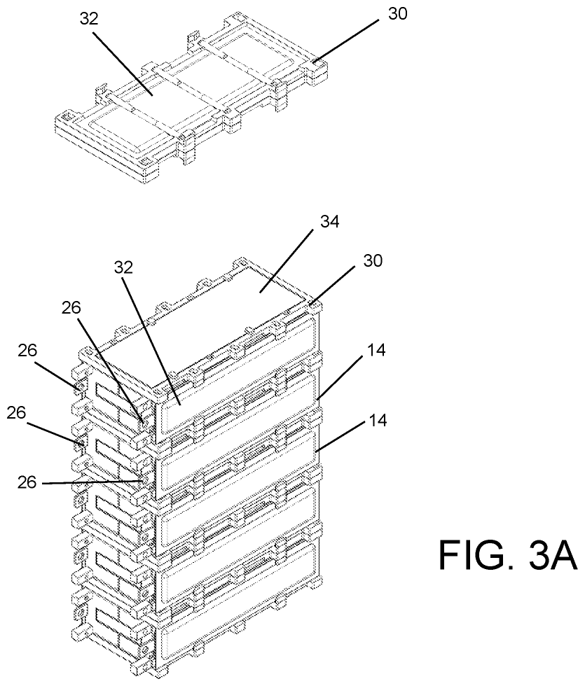

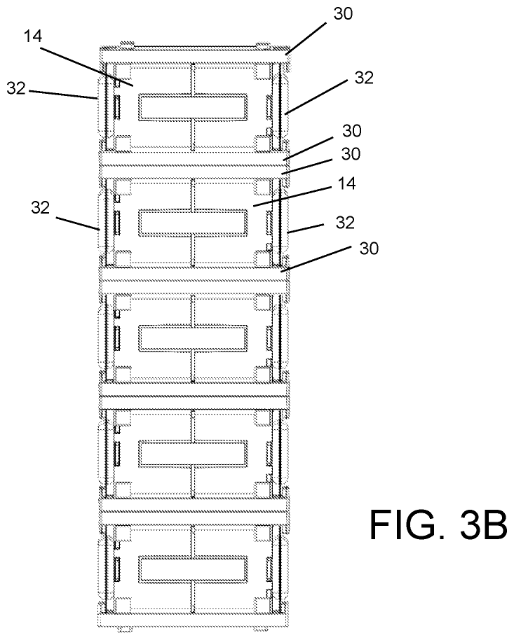

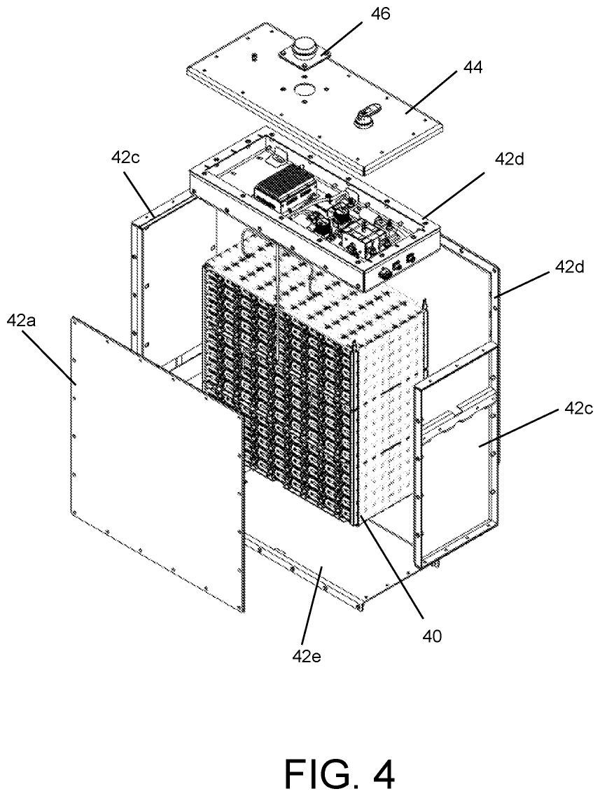

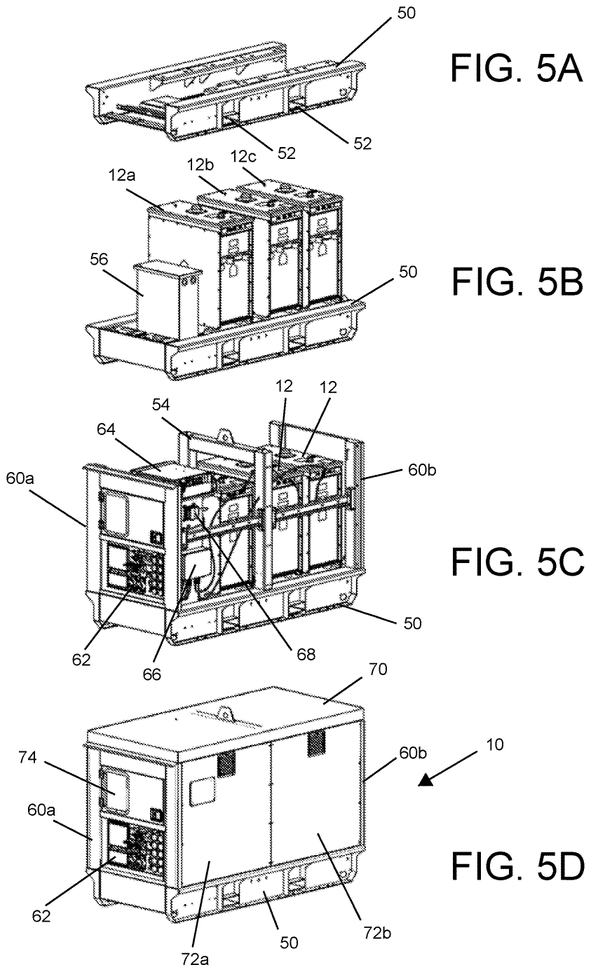

With reference to FIGS. 1, 2, 3A, 3B, 4, 5A, 5B, 5C, and 5D, a portable battery system 10 is provided. As best depicted in FIGS. 4, 5B and 5C, the portable battery system 10 is composed of one or more battery packs 12. Preferably, three battery packs 12 are provided. As best depicted in FIGS. 2A, 2B, 3A, and 3B, each of the battery packs 12 are formed of a plurality of battery modules 14 for supplying electrical power at a DC voltage.

With specific reference to FIGS. 2A and 2B, the modules 14 are each formed of a plurality of battery cells 20. While sixteen battery cells 20 are depicted, any suitable number of cells 20 could be employed without departing from the invention. The cells 20 are retained between a top module frame 22a and a bottom module frame 22b configured to receive and retain the cells 20. A thermal barrier in the form of inner phenolic sheets 24 are retained in between the module frames 22a, 22b to provide separation and insulation between each of the cells 20 in the event of a thermal runaway event. The thermal barriers 24 are formed of a suitably heat resistant material such as phenolic having known properties that contain the heat. Electrical conducting components (not shown) are included in each module to make electrical contact with the cells 20, to enable conduction of electricity from the cells 20 during use of the system 10, and to enable charging of the cells 20.

Specific reference is now made to FIGS. 3A and 3B which depict how the modules 14 are stacked. Each module 14 includes electrical contacts 26 for establishing electrical connections between the battery cells 20 in each module 14 and the larger battery component 12. Each module 14 is stacked atop another module 14 using a stacking frame 30, as described in the co-pending application U.S. Ser. No. 17/933,966 entitled STACKING FRAME AND COOLING SYSTEM FOR BATTERY CELLS, commonly assigned to the present assignee, the entirety of the disclosure of which is hereby incorporated by reference.

With continued reference to FIGS. 3A and 3B, the modules 14 are surrounded on the tops, bottoms, and sides by thermal runaway shield (TRS) pouches 32 that are enclosed between stacking frames 30. Each TRS pouch 32 is a coated aluminum pouch that includes a thermally cooling fluid that ruptures into the battery module from heat produced in a thermal runaway event in the battery module 14. The TRS pouches 32 are preferably of a type manufactured by KULR Technology Group, Inc. Top phenolic sheets 34 are placed along the tops and bottoms of each module 14 to provide a thermal barrier respectively between the TRS pouches 32 of adjoining modules 14. The top phenolic sheets 34 are formed to be suitably heat resistant and have known properties that contain the heat. In this manner, the top phenolic sheets 34 allow a TRS pouch 32 of an associated module 14 to rupture and quench thermal runaway within the module while protecting a TRS pouch 32 of the adjoining module 14 from prematurely rupturing unless the heat in the adjoining module 14 is sufficiently high that the associated pouch 32 is required to extinguish the flame. Thus, the top phenolic sheets 34 prevents transfer of heat from thermal runaway to modules 14 above or below.

With specific reference to FIG. 4, the stacked modules 14 are assembled into a battery component 12 as described in the co-pending application U.S. Ser. No. 17/933,976 entitled BATTERY PACK SYSTEM AND METHOD FOR MITIGATING AND RESPONDING TO THERMAL RUNAWAY, commonly assigned to the present assignee, the entirety of the disclosure of which is hereby incorporated by reference. The battery component 12 includes an array 40 of stacked modules 14 which are each configured and electrically connected for communications with a battery management system. The battery pack 12 includes a front plate 42a, a back plate 42b, two side plates 42c, a top plate 42d and a bottom plate 42, all of which are joined together to create a water-tight, sealed enclosure for retaining the plurality of battery modules 14 within the battery component 12. The battery component 12 is covered with a cover plate 44 which includes a vent cap 46 for venting the interior of the air-tight, sealed enclosure in the event of an explosion resulting from a thermal runaway event.

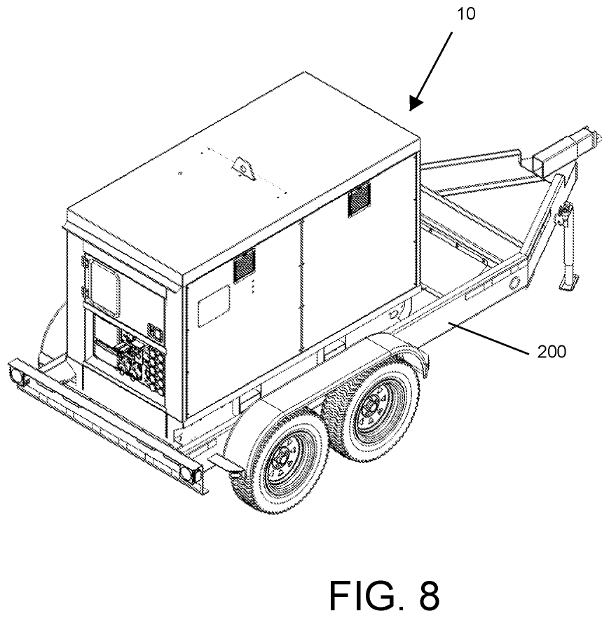

FIGS. 5A, 5B, 5C, and 5D depict assembly steps in constructing the portable battery system 10. As shown in FIG. 5A, a portable support structure is provided for supporting and moveably transporting components of the portable battery system 10 including the battery components 12, including a master battery pack 12a, a remote 1 battery pack 12b, and a remote 2 battery pack 12c. In one aspect, the portable support structure is a lower skid 50 having apertures 52 specially sized and placed along the lower skid 50 to admit the forks of a forklift, so that the portable battery system 10 can be raised and lowered by the forklift. The lower skid 50 can be configured to be received onto a wheeled transport apparatus 200. For example, as shown in FIG. 8, the wheeled transport apparatus 200 can be a flatbed truck or a trailer that can be towed by a truck.

As shown in FIG. 5B, three battery components 12a, 12b, 12c are mounted onto the lower skid 50. An AC transformer 56 is provided for selectively enabling conversion from a 480V, 3-phase supply to a 208V, 3-phase supply, depending on the specific needs at the point of use.

As shown in FIG. 5C, a mid upright support 54 is mounted to the lower skid 50 to provide structural integrity to the system 10. Rear and front upright supports 60a, 60b are provided at either end of the system 10. The rear upright support 60a includes a power interface panel 62 having ports and connectors for establishing electrical power connections and communications connections for communicating with remote systems. A DC/AC inverter 64 is provided for converting the 600 VDC input from the system 10 into a standard 480V 3-phase AC output (up to 20 KW). A high voltage DC power distribution unit 66 is provided, along with a low voltage DC power distribution unit 68. A control system 300 is also provided for control features, as described in greater detail hereinbelow.

As shown in FIGS. 1 and 5D, a lid 70 is provided along with removable panels 72a, 72b for completing the assembly of the portable battery system 10. An operator interface panel 74 provides user controls for operating the system 10. In this manner, the present portable battery system 10 is a full containerized battery solution. In a practical working implementation, the present portable battery system 10 has dimensions of 4 feet wide, 5 feet high, 9 feet long, and weighs approximately 70,000 lbs. The number of work hours outputted from the battery system 10 can vary with the load. The system 10 can preferably retain 131 kWh of usable energy. At maximum output of 30 kW, it can provide 4.4 hours of power. At a nominal load of 7 kW it can provide 18 hours.

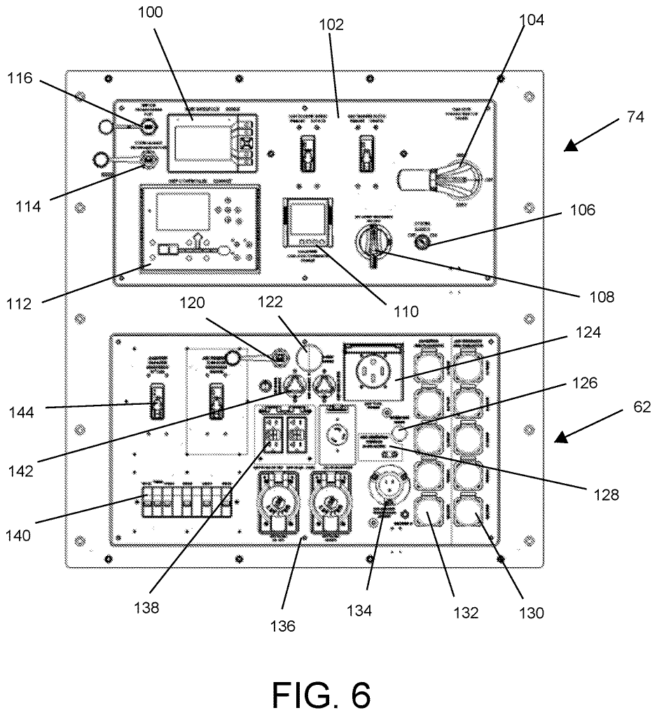

With reference to FIG. 6, the operator interface panel 74 and power interface panel 162 are shown in detail. The operator interface 74 includes a main display controller 100, 3-phase primary circuit breakers 102, a transfer switch 104, a main power key switch 106, and a low voltage DC disconnect switch 108. The operator interface panel 74 also includes a grid/load AC voltage sensor/current sensor 110, a generator synch controller/AC voltage/current sensor 112, ethernet programming port 114 and a USB programming port 116.

With continuing reference to FIG. 6, the power interface panel 62 includes an ethernet communication port 120, an E-stop switch 122, a 120/208V 1-phase AC outlet 124, a power live indicator 126, a generator autostart connector 128, and a camlock 3-phase AC generator connection 130. The power interface panel 62 also includes a camlock 3-phase AC grid/load connection 130, a 24V battery charger connector 134, 120/208V 1-phase AC outlets 136, 120V 1-phase AC outlets 138, 1-phase circuit breakers 140, CAN communication ports 142, and 3-phase secondary circuit breakers 144.

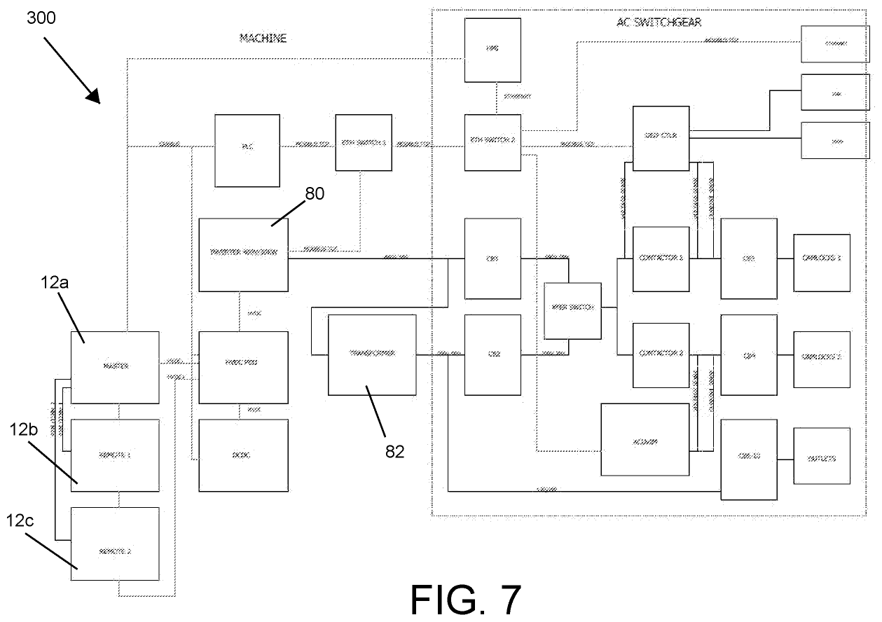

With reference to FIG. 7, the three battery components 12 of the present portable battery system 10 includes a master battery 12a and two remote batteries, a remote 1 battery pack 12b and a remote 2 battery pack 12c. An inverter 80 is provided for converting DC current from the batteries 12a, 12b, 12c into AC current consumable by the loads. at the remote construction site. Various related electronics components are depicted for supporting these functions.

With continuing reference to FIG. 7, a transformer 82 is provided for converting the electrical power supplied by the inverter 64 from the primary voltage (480VAC) to a secondary voltage (208VAC). In the preferred embodiment, the transformer 82 is configured to convert the electrical power from a base voltage of 480 volts to an alternate voltage of 208 volts. However, it is to be appreciated that the system 10 could be configured to supply any suitable base voltage and any number of desired alternate voltages, all without departing from the invention.

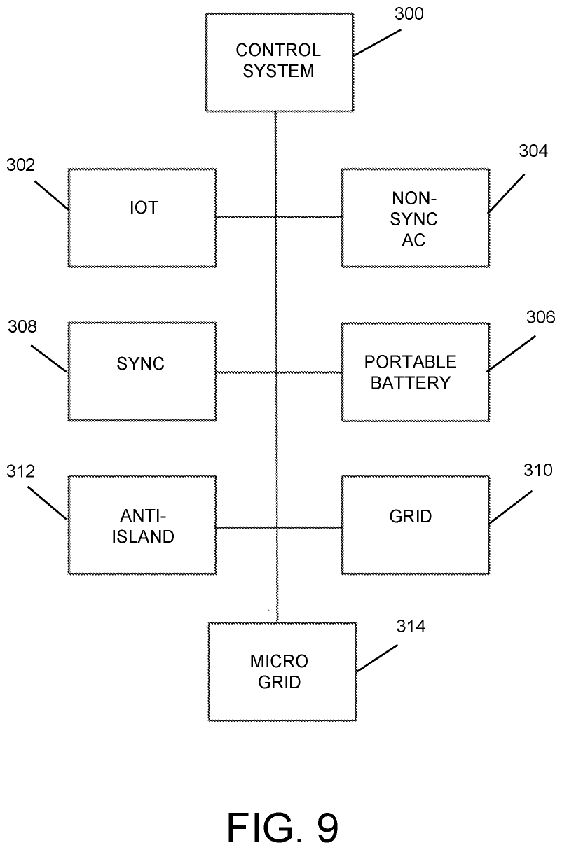

As mentioned hereinabove and as further depicted in FIG. 9, the present portable battery system 10 includes the control system 300 for monitoring battery parameters and implementing one or more control function in response to the monitoring. The battery parameters include battery charge level or temperature. The control system 300 also includes an “internet of things” (IOT) interface 302 for remotely performing the monitoring and implementing. As depicted herewith, the present control system 300 can synchronize with one or more non-synchronous AC devices 302. Such a non-synchronous AC device 304 can include a non-synchronous generator. The control system 300 can be connected in parallel with one or more additional portable battery systems 306. In one aspect, the control system 300 can be connected in parallel to one or more synchronous generators 308. The control system 300 for connecting to and synchronizing with an electrical grid 310 in order to charge from the grid and discharge into the grid. The control system 300 can include an anti-islanding protection component 312 to prevent back feeding into the grid when the grid shuts down. Alternatively, the control system 300 can form a microgrid system 314.

As generally indicated in FIGS. 1, 5C, and 5D, the power interface panel 62 of the portable battery system 10 includes an electrical connection 84 to a backup system that provides electrical charging upon depletion of the battery system. Preferably, the backup system is a diesel generator that is “hybridized” with the portable battery system 10 to create a hybrid system analogous to a hybrid vehicle. The portable battery system 10 connects to the diesel generator and communicate with it, synchronize waveforms. In this way, the diesel generator can charge the battery system 10 and operate continuously at its maximum output, to operate at its maximum efficiency, instead of intermittently providing power to tools and lighting, etc. and thereby operating at 10-20% efficiency as with standard diesel generator systems.

Numerous embodiments have been described herein. It will be apparent to those skilled in the art that the above methods and apparatuses may incorporate changes and modifications without departing from the general scope of this invention. It is intended to include all such modifications and alterations in so far as they come within the scope of the appended claims or the equivalents thereof.

Having thus described the invention, it is now claimed:

1-15. (canceled)

16. A battery system, comprising:
a sealed enclosure;
a plurality of battery modules within the sealed enclosure for supplying electrical power at a base voltage;
at least one thermal runaway shield (TRS) pouch associated with each of the plurality of battery modules, the at least one TRS pouch including a thermally cooling fluid that ruptures into the battery module from heat produced in a thermal runaway event in the battery module;
a pressure monitoring sensor for detecting an increase in air pressure within the sealed enclosure, wherein the increase in air pressure is associated with gas released from the thermal runaway event in at least one of the battery modules;
a control system remotely coupled to the pressure monitoring sensor for implementing at least one control function to at least one of the battery modules in response to the pressure monitoring sensor.

17. The battery system of claim 16, wherein the plurality of battery modules comprises at least a first battery module and a second battery module, wherein the system further comprises a stacking frame disposed between the first and second battery modules.

18. The battery system of claim 17, further comprising a reinforcement sheet disposed between the TRS pouch in the first battery module and the TRS pouch in the second battery module.

19. The portable battery system of claim 16, wherein the control function adjusts one or more battery parameters of at least one of the battery modules.

20. The portable battery system of claim 19, wherein the one or more battery parameters comprise at least one of battery charge level or temperature.

21. The portable battery system of claim 16, wherein the control system comprises an “internet of things” (IOT) interface for remotely performing the implementing.

22. The portable battery system of claim 20, wherein the control system synchronizes with at least one non-synchronous AC device.

23. The portable battery system of claim 24, wherein the non-synchronous AC device comprises a non-synchronous generator.

24. The portable battery system of claim 16, wherein the control system is connected in parallel with at least one additional portable battery system.

25. The portable battery system of claim 16, further comprising a portable support structure for supporting and moveably transporting components of the portable battery system including the at least one battery component.

26. A battery system, comprising:
a sealed enclosure;
first and second battery modules within the sealed enclosure for supplying electrical power at a base voltage;
at least one thermal runaway shield (TRS) pouch associated with each of the plurality of battery modules, the at least one TRS pouch including a thermally cooling fluid that ruptures into the battery module from heat produced in a thermal runaway event in the battery module;
a heat resistant reinforcement sheet disposed between the TRS pouch in the first battery module and the TRS pouch in the second battery module; and
a pressure monitoring sensor for detecting an increase in air pressure within the sealed enclosure, wherein the increase in air pressure is associated with gas released from the thermal runaway event in at least one of the battery modules.

27. The battery system of claim 26, wherein the reinforcement sheet comprises a phenolic material.

28. The battery system of claim 26, further comprising a third battery module and a second heat resistant reinforcement sheet disposed between the TRS pouches in the second and third battery modules.

29. The battery system of claim 26, further comprising a stacking frame disposed between the first and second battery modules.

30. The battery system of claim 26, further comprising a control system remotely coupled to the pressure monitoring sensor for implementing at least one control function to at least one of the battery modules in response to the pressure monitoring sensor.

31. The portable battery system of claim 30, wherein the control function adjusts one or more battery parameters of at least one of the battery modules.

32. The portable battery system of claim 21, wherein the one or more battery parameters comprise at least one of battery charge level or temperature.

33. The portable battery system of claim 30, wherein the control system synchronizes with at least one non-synchronous AC device.

34. The portable battery system of claim 33, wherein the non-synchronous AC device comprises a non-synchronous generator.

35. The portable battery system of claim 26, further comprising a portable support structure for supporting and moveably transporting components of the portable battery system including the at least one battery component.
